(19) United States
(12) Patent Application Publication
(10) Pub. No.: US 2010/0256322 A1
(43) Pub. Date: Oct. 7, 2010

(54) METHOD FOR PRODUCING HYDROXY-FUNCTIONAL POLYMERS, THE ISOCYANATE-GROUP-TERMINATED POLYADDITION PRODUCTS WHICH CAN BE OBTAINED THEREFROM, AND THE USE THEREOF

(75) Inventors: Andreas Kramer, Zurich (CH); Jurgen Finter, Zurich (CH)

Correspondence Address: OLIFF & BERRIDGE, PLC, P.O. BOX 320850, ALEXANDRIA, VA, 22320-4850, US

(73) Assignee: Sika Technology AG, Baar (CH)

(21) Appl. No.: 12/746,082

(22) PCT Filed: Dec. 15, 2008
(86) PCT No.: PCT/EP08/67478

§ 371 Date: Jun. 3, 2010

(30) Foreign Application Priority Data
Dec. 17, 2007 (EP) 07150049.0

(51) Int. Cl. C08G 18/16; C08G 18/08

(52) U.S. Cl. 528/51; 528/66; 528/65; 528/60

(57) ABSTRACT

The invention relates to a method for producing polyurethanes, based on the reaction of a polymer, which has hydroxyl groups, and a polyisocyanate. Furthermore, the present invention relates to an isocyanate-group-terminated polyaddition product produced according to this method, an adhesive which contains such an isocyanate-group-terminated polyaddition product, and the use of the polyaddition product as a curing component in adhesives. The polyurethanes according to the invention are obtained by reacting at least one polymer (A), which has at least two hydroxyl groups and which is obtained by the reaction of a polymer having at least two carboxyl and/or phenol groups of the formula (I) or (II) with a least one compound having at least one glycidyl group, with at least one polyisocyanate (B).

### TECHNICAL FIELD

The invention relates to a method for producing polyurethanes, based on the reaction of a hydroxyl-containing polymer and a polyisocyanate. The present invention further relates to an isocyanate-group-terminal polyaddition product produced by this method, to an adhesive which comprises such an isocyanate-group-terminal polyaddition product, and to the use of the polyaddition product as a curing component in adhesives.

### PRIOR ART

Polyurethanes (PU; DIN abbreviation: PUR) are plastics or synthetic resins which are formed from the polyaddition reaction of diols, and/or polyols, with polyisocyanates.

Polyurethanes may have different properties according to the choice of isocyanate and of polyol. The later properties are substantially determined by the polyol component, since often, in order to achieve desired properties, it is not the isocyanate component but rather the polyol component which is adapted (i.e., chemically modified).

Numerous products are produced from PU, such as seals, hoses, flooring, coatings, and, in particular, adhesives as well, for example.

Within the industry, moreover, specialty copolymers have been used for a long time that are referred to as liquid rubbers. Through the use of chemically reactive groups, such as epoxide, carboxyl, vinyl or amino groups, liquid rubbers of this kind can be incorporated chemically into the matrix. Thus, for example, for a long time there have been reactive liquid rubbers comprising butadiene/acrylonitrile copolymers, which are terminated with epoxide, carboxyl, vinyl or amino groups and which are available from the company B.V. Goodrich, or Noveon, under the trade name Hycar®.

The starting basis used for these products is always the carboxyl-terminated butadiene/acrylonitrile copolymer (CTBN) to which typically a large excess of a diamine, diepoxide or glycidyl(meth)acrylate is added. This, however, means that on the one hand a high viscosity is formed or on the other hand there is a very high level of unreacted diamine, diepoxide or glycidyl(meth)acrylate, which either has to be removed, which is costly and inconvenient, or else very adversely affects the mechanical properties.

The use of epoxide-, carboxyl-, amine- or vinyl-functional butadiene/acrylonitrile polymers of this kind in adhesives is already known.

Hydroxyl-functional variants thereof, which are of greater interest for polyurethane chemistry than amino-functional products, and which serve as polyols for reaction with the isocyanate component, are technically demanding, costly, and inconvenient to prepare, and are mostly obtained by reacting CTBN with ethylene oxide. This produces primary alcohol end groups. The polyethylene glycol groups formed in this way, moreover, are disadvantageous in contact with water.

For example, U.S. Pat. No. 4,444,692 discloses the production of hydroxyl-terminated reactive liquid polymers by reaction of ethylene oxide in the presence of an amine catalyst with a carboxyl-terminated reactive liquid polymer. This produces, as indicated above, primary alcohol end groups in the polymer.

U.S. Pat. No. 3,712,916 likewise describes hydroxyl-terminated polymers which are useful as adhesives and sealing materials. These hydroxyl-terminated polymers are produced by reacting carboxyl-terminated polymers likewise with ethylene oxides in the presence of a tertiary amino catalyst.

Other pathways to the production of hydroxyl-functional variants are the reaction of the terminal carboxylic acids with amino alcohols, and/or low molecular mass diols. In both cases it is necessary to operate with large excesses, and this makes work-up costly and inconvenient.

U.S. Pat. No. 4,489,008 discloses hydrolytically stable, hydroxyl-terminated liquid polymers which are of use in the production of polyurethanes. They are produced by reacting at least one amino alcohol with a carboxyl-terminated polymer. The reaction of a carboxyl-terminated polymer with at least one compound which has at least one glycidyl group is not disclosed. Relative to the conventional polyurethanes, the improved hydrolytic stability of the end product is emphasized.

U.S. Pat. No. 3,551,472 describes hydroxyl-terminated polymers which are produced by reacting carboxyl-terminated polymers with a C₃-C₆ alkylenediol in the presence of an acidic catalyst. It is said that these polymers are of benefit as adhesives and sealing materials.

U.S. Pat. No. 3,699,153 likewise describes hydroxyl-terminated polymers which are produced by reacting carboxyl-terminated polymers with a C₃-C₆ alkylenediol.

### SUMMARY OF THE INVENTION

The object on which the present invention is based is that of providing improved polyurethane compositions, more particularly adhesives, sealants and primers, which exhibit improved adhesion to a wide variety of substrates. A further object of the present invention is to provide toughness improvers having functional end groups that are capable of overcoming the problems stated in the prior art, and more particularly of avoiding the technically demanding, costly, and inconvenient reaction of the carboxyl-terminated polymers with ethylene oxide.

These objects are achieved by the subject matter of independent claims 1, 16, 18, 19, 20, and 21. Preferred embodiments are apparent from the dependent claims.

The method of the invention for producing polyurethanes provides an alternative and improved pathway to the reaction of polymers containing carboxyl groups and/or phenol groups to form hydroxyl-functional variants. Instead of ethylene oxide, which on toxicological grounds possesses a hazard potential (or the use of diols and/or amino alcohols), compounds having at least one glycidyl group are used, i.e., relatively high molecular mass epoxides, whose use produces secondary alcohols. Through the use of readily accessible, easy-to-handle and toxicologically non-hazardous bisphenol A diglycidyl ethers or cresyl glycidyl ethers, for example, it is possible in a simple way to introduce aromatic structures, which may lead to a significant increase in mechanical properties in the polyurethanes. These reaction products, moreover, have high stability to hydrolysis.

The invention finds its advantage, in addition to simplifying and improving the production method itself, in particular by virtue of the fact that the hydroxyl-functional polymers, obtained by reaction of carboxyl- and/or phenol-group-containing polymers with a compound having at least one glycidyl group, produce—through reaction with polyisocyanates to give polyurethanes—an end product which as compared with the conventional products has improved properties in respect of adhesion, toughness modification, and hydrolytic stability.

As already emphasized at the outset, the polyurethanes produced in accordance with the invention, or the isocyanate-terminal polyaddition products arising from a reaction of the abovementioned polymers with polyisocyanate, find application in adhesives. The hydroxyl-functional polymer finds application, more particularly, as a curing component or as part of a curing component in two-pack adhesives.

### EMBODIMENTS OF THE INVENTION

According to a first aspect, the present invention provides a method for producing polyurethanes, comprising the steps of:
(a) providing at least one polymer (A) which has at least two hydroxyl groups and which is obtained by the reaction of a polymer having at least two carboxyl groups and/or phenol groups of the formula (I) or (II) with at least one compound having at least one glycidyl group;
(b) reacting the at least one polymer (A) with at least one polyisocyanate (B).

In a first embodiment, carboxyl-terminated polymers of the formula (I) are used for preparing polymer (A). It can be obtained by reaction of hydroxyl-, amine- or thiol-terminal polymers with dicarboxylic acids and/or their anhydrides.

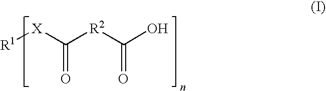

X here is O, S or NR⁴, and R⁴ is H or an alkyl group having 1 to 10 carbon atoms. R¹ is an n-valent radical of a polymer R¹—[XH]ₙ following the removal of the terminal-XH groups. R² is a radical of a dicarboxylic acid following removal of the two carboxyl groups, more particularly a saturated or unsaturated, optionally substituted alkylene group having 1 to 6 carbon atoms, or an optionally substituted phenylene group.

In a second embodiment, hydroxyphenyl-terminal polymers of the formula (II) are used for preparing polymer (A). They can be obtained by the reaction of hydroxyl-, amine- or thiol-terminal polymers with hydroxyphenyl-functional carboxylic acids or their esters.

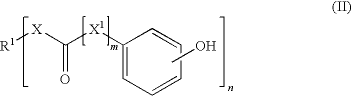

Here, X¹ is NR⁴, CH₂ or C₂H₄, and m is 0 or 1. R¹, X, NR⁴, and n have already been defined above.

It will be understood, however, that the preparation of the polymer with at least two carboxyl and/or phenol groups is not confined to these preparation pathways indicated above, and that the person skilled in the art is able at any time to employ alternative methods.

The prefix “poly”, which is used in the present invention for substance names such as “polyisocyanate”, is generally an indication that the substance in question formally contains more than one per molecule of the functional group that occurs in its name.

“Phenol groups” are understood in the present document to be hydroxyl groups which are attached directly to an aromatic nucleus, irrespective of whether one or else two or more such hydroxyl groups are attached directly to the nucleus.

In one embodiment the polymer (A) is obtained by a reaction of carboxyl-terminated polymers having a functionality of at least 2 with aromatic glycidyl ethers.

The glycidyl group used in accordance with the invention preferably involves glycidyl ethers, glycidyl esters, glycidylamine, glycidylamide or glycidylimide. The “glycidyl ether group” in this context is the group of the formula

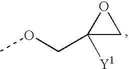

where Y¹ is H or methyl.

The “glycidyl ester group” in this context is the group of the formula

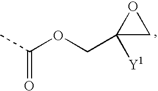

where Y¹ is H or methyl.

The compound having at least one glycidyl group is selected with particular preference from glycidyl esters or glycidyl ethers having a functionality of one, two or more.

In one embodiment the diglycidyl ether is an aliphatic or cycloaliphatic diglycidyl ether, more particularly a diglycidyl ether of difunctional saturated or unsaturated, branched or unbranched, cyclic or open-chain C₂-C₃₀ alcohols, e.g., ethylene glycol, butanediol, hexanediol or octanediol diglycidyl ether, cyclohexanedimethanol diglycidyl ether, neopentyl glycol diglycidyl ether. The diglycidyl ether is for example an aliphatic or cycloaliphatic diglycidyl ether, more particularly a diglycidyl ether of the formula (III) or (IV)

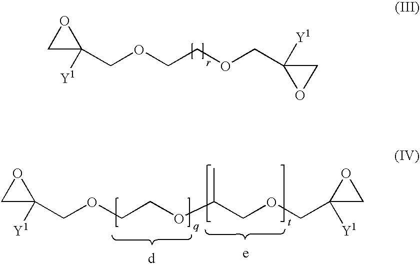

In these formulae, r is a value from 1 to 9, more particularly 3 or 5. Moreover, q is a value from 0 to 10 and t is a value from 0 to 10, with the proviso that the sum of q and t is 1. Finally, d represents the structural element which originates from ethylene oxide, and e represents the structural element which originates from propylene oxide. Formula (IV) therefore involves (poly)ethylene glycol diglycidyl ethers, (poly)propylene glycol diglycidyl ethers and (poly)ethylene glycol/propylene glycol diglycidyl ethers, it being possible for the units d and e to be arranged blockwise, alternatingly or randomly.

Particularly suitable aliphatic or cycloaliphatic diglycidyl ethers are propylene glycol diglycidyl ether, butanediol diglycidyl ether or hexanediol diglycidyl ether. Particularly preferred examples of glycidyl ethers and esters are selected from the group consisting of glycidyl neodecanoate, glycidyl benzoate, diglycidyl phthalate, octyl glycidyl ether, decyl glycidyl ether, butanediol diglycidyl ether, hexanediol diglycidyl ether, cyclohexanedimethanol diglycidyl ether, trimethylolpropane triglycidyl ether, tert-butylphenol glycidyl ether, cresyl glycidyl ether, Cardanol glycidyl ether (Cardanol=3-pentadecenylphenol (from cashew nut shell oil)), diglycidyl ethers of bisphenols, more particularly solid epoxy resins, liquid epoxy resins, bisphenol F diglycidyl ether (distilled and undistilled), bisphenol A diglycidyl ether (distilled and undistilled), preferably bisphenol A diglycidyl ether (distilled or undistilled).

Besides glycidyl ethers or glycidyl esters it is also possible in accordance with the invention, as addressed above, to use amine-glycidyl compounds. Corresponding examples of such compounds that may be named include the following by way of example:

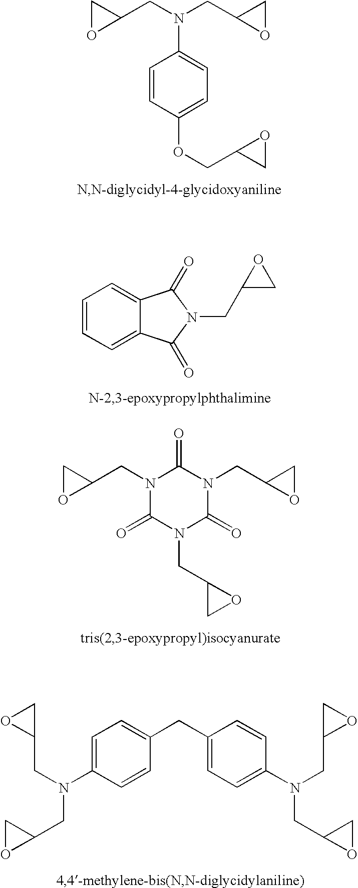

In one embodiment the polymer (A) is prepared by reaction of at least one carboxyl-terminated polymer of the formula (I) with at least one glycidyl ether or glycidyl ester, thus forming, as polymer of the formula (A-1), a polymer of the formula (A-1).

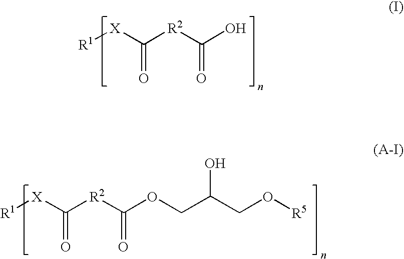

In another embodiment the polymer (A) is prepared by reaction of at least one phenol-group-containing polymer of the formula (II) with at least one glycidyl ether or glycidyl ester. The reaction then takes place, accordingly, to form the polymer of the formula (A-II)

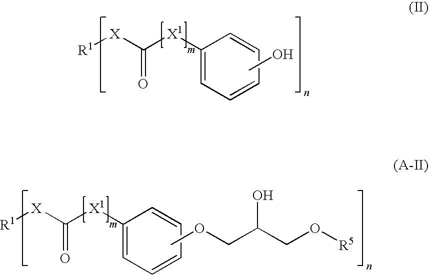

Preferably R¹ is a poly(oxyalkylene) polyol, polyester polyol, poly(oxyalkylene)polyamine, polyalkylene polyol, polycarbonate polyol, polymercaptan or polyhydroxypolyurethane following removal of the hydroxyl, amine or mercaptan groups.

In one embodiment R¹—[XH]ₙ is a polyol. Polyols of this kind are preferably diols or triols, more particularly
polyoxyalkylene polyols, also called polyether polyols, which are the polymerization product of ethylene oxide, 1,2-propylene oxide, 1,2- or 2,3-butylene oxide, oxetane, tetrahydrofuran or mixtures thereof, optionally polymerized using a starter molecule having two or three active H atoms, such as water or compounds having two or three OH groups, for example. Use may be made both of polyoxyalkylene polyols which have a low degree of unsaturation (measured in accordance with ASTM D-2849-69 and expressed in milliequivalents of unsaturation per gram of polyol (meq/g)), prepared, for example, using what are called double metal cyanide complex catalysts (DMC catalysts for short), and of polyoxyalkylene polyols having a higher degree of unsaturation, prepared, for example, using anionic catalysts such as NaOH, KOH or alkali metal alkoxides. Particularly suitable are polyoxypropylene diols and triols having a degree of unsaturation of less than 0.02 meq/g and having a molecular weight in the range of 300-20 000 daltons, polyoxybutylene diols and triols, polyoxypropylene diols and triols having a molecular weight of 400-8000 daltons, and also what are called EO-endcapped (ethylene oxide-endcapped) polyoxypropylene diols or trials. The latter are special polyoxypropylene-polyoxyethylene polyols which are obtained, for example, by alkoxylating pure polyoxypropylene polyols with ethylene oxide after the end of the polypropoxylation, and which as a result contain primary hydroxyl groups;
hydroxy-terminated polybutadiene polyols, such as, for example, those prepared by polymerization of 1,3-butadiene and allyl alcohol or by oxidation of polybutadiene, and also their hydrogenation products;
styrene-acrylonitrile grafted polyether polyols, of the kind supplied, for example, by Elastogran under the Lupranol® name;
polyester polyols prepared, for example, from dihydric to trihydric alcohols such as, for example, 1,2-ethanediol, diethylene glycol, 1,2-propanediol, dipropylene glycol, 1,4-butanediol, 1,5-pentanediol, 1,6-hexanediol, neopentyl glycol, glycerol, 1,1,1-trimethylolpropane or mixtures of the aforementioned alcohols with organic dicarboxylic acids or their anhydrides or esters, such as, for example, succinic acid, glutaric acid, adipic acid, suberic acid, sebacic acid, dodecanedicarboxylic acid, maleic acid, fumaric acid, phthalic acid, isophthalic acid, terephthalic acid, and hexahydrophthalic acid, or mixtures of the aforementioned acids, and also polyester polyols from lactones such as ε-caprolactone, for example;
polycarbonate polyols, of the kind obtainable by reaction, for example, of the abovementioned alcohols—those used to construct the polyester polyols—with dialkyl carbonates, diaryl carbonates or phosgene;
1,2-ethanediol, diethylene glycol, 1,2-propanediol, dipropylene glycol, 1,4-butanediol, 1,5-pentanediol, 1,6-hexanediol, 1,7-heptanediol, octanediol, nonanediol, decanediol, neopentyl glycol, pentaerythritol (=2,2-bishydroxymethyl-1,3-propanediol), dipentaerythritol (=3-(3-hydroxy-2,2-bishydroxymethylpropoxy)-2,2-bishydroxymethylpropan-1-ol), glycerol (=1,2,3-propanediol), trimethylolpropane (=2-ethyl-2-(hydroxymethyl)-1,3-propanediol), trimethylolethane (=2-(hydroxymethyl)-2-methyl-1,3-propanediol), di(trimethylolpropane) (=3-(2,2-bishydroxymethylbutoxy)-2-ethyl-2-hydroxymethylpropan-1-ol), di(trimethylolethane) (=3-(3-hydroxy-2-hydroxymethyl-2-methyl propoxy)-2-hydroxymethyl-2-methylpropan-1-ol), diglycerol (=bis(2,3-dihydroxypropyl)ether);
polyols of the kind obtained by reduction of dimerized fatty acids.

In another embodiment R¹—[XH]ₙ is a polyamine. Polyamines of this kind are more particularly diamines or triamines, preferably aliphatic or cycloaliphatic diamines or triamines. More particularly these are polyoxyalkylene-polyamines having two or three amino groups, as for example obtainable under the Jeffamine® name (from Huntsman Chemicals), under the Polyetheramine name (from BASF) or under the PC Amine® name (from Nitroil), and also mixtures of the aforementioned polyamines.

Preferred diamines are polyoxyalkylene-polyamines have two amino groups, more particularly those of the formula (V).

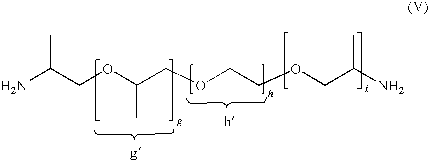

In this formula, g′ is the structural element originating from propylene oxide, and h′ the structural element originating from ethylene oxide. Moreover, g, h and i are each values from 0 to 40, with the proviso that the sum of g, h, and i is ≧1.

More particularly preferred are molecular weights between 200 and 10 000 g/mol.

More particularly preferred diamines are Jeffamine®, as sold under the D line and ED line by Huntsman Chemicals, such as, for example, Jeffamine® D-230, Jeffamine® D-400, Jeffamine® D-2000, Jeffamine® D-4000, Jeffamine® ED-600, Jeffamine® ED-900 or Jeffamine® ED-2003.

Further preferred triamines are sold, for example, under the Jeffamine® T line by Huntsman Chemicals, such as, for example, Jeffamine® T-3000, Jeffamine® T-5000 or Jeffamine® T-403.

In another embodiment R¹—[XH]ₙ is a polymercaptan. Suitable polymercaptans are, for example, polymercaptocetates of polyols. These are more particularly polymercaptocetates of the following polyols:
polyoxyalkylene polyols, also called polyether polyols, which are the polymerization product of ethylene oxide, 1,2-propylene oxide, 1,2- or 2,3-butylene oxide, tetrahydrofuran or mixtures thereof, optionally polymerized using a starter molecule having two or three active H atoms, such as water or compounds having two or three OH groups, for example. Use may be made both of polyoxyalkylene polyols which have a low degree of unsaturation (measured in accordance with ASTM D-2849-69 and expressed in milliequivalents of unsaturation per gram of polyol (meq/g)), prepared, for example, using what are called double metal cyanide complex catalysts (DMC catalysts for short), and of polyoxyalkylene polyols having a higher degree of unsaturation, prepared, for example, using anionic catalysts such as NaOH, KOH or alkali metal alkoxides. Particularly suitable are polyoxypropylene dials and triols having a degree of unsaturation of less than 0.02 meq/g and having a molecular weight in the range of 300-20 000 daltons, polyoxybutylene diols and triols, polyoxypropylene diols and triols having a molecular weight of 400-8000 daltons, and also what are called EO-endcapped (ethylene oxide-endcapped) polyoxypropylene diols or triols. The latter are special polyoxypropylene-polyoxyethylene polyols which are obtained, for example, by alkoxylating pure polyoxypropylene polyols with ethylene oxide after the end of the polypropoxylation, and which as a result contain primary hydroxyl groups;
hydroxy-terminated polybutadiene polyols, such as, for example, those prepared by polymerization of 1,3-butadiene and allyl alcohol or by oxidation of polybutadiene, and also their hydrogenation products;
styrene-acrylonitrile grafted polyether polyols, of the kind supplied, for example, by Elastogran under the Lupranol® name;
polyester polyols prepared, for example, from dihydric to trihydric alcohols such as, for example, 1,2-ethanediol, diethylene glycol, 1,2-propanediol, dipropylene glycol, 1,4-butanediol, 1,5-pentanediol, 1,6-hexanediol, neopentyl glycol, glycerol, 1,1,1-trimethylolpropane or mixtures of the aforementioned alcohols with organic dicarboxylic acids or their anhydrides or esters, such as, for example, succinic acid, glutaric acid, adipic acid, suberic acid, sebacic acid, dodecanedicarboxylic acid, maleic acid, fumaric acid, phthalic acid, isophthalic acid, terephthalic acid, and hexahydrophthalic acid, or mixtures of the aforementioned acids, and also polyester polyols from lactones such as ε-caprolactone, for example;
polycarbonate polyols, of the kind obtainable by reaction, for example, of the abovementioned alcohols—those used to construct the polyester polyols—with dialkyl carbonates, diaryl carbonates or phosgene;
1,2-ethanediol, diethylene glycol, 1,2-propanediol, dipropylene glycol, 1,4-butanediol, 1,5-pentanediol, 1,6-hexanediol, 1,7-heptanediol, octanediol, nonanediol, decanediol, neopentyl glycol, pentaerythritol (=2,2-bishydroxymethyl-1,3-propanediol), dipentaerythritol (=3-(3-hydroxy-2,2-bishydroxymethylpropoxy)-2,2-bishydroxymethylpropan-1-ol), glycerol (=1,2,3-propanediol), trimethylolpropane (=2-ethyl-2-(hydroxymethyl)-1,3-propanediol), trimethylolethane (=2-(hydroxymethyl)-2-methyl-1,3-propanediol), di(trimethylolpropane) (=3-(2,2-bishydroxymethylbutoxy)-2-ethyl-2-hydroxymethylpropan-1-ol), di(trimethylolethane) (=3-(3-hydroxy-2-hydroxymethyl-2-methylpropoxy)-2-hydroxymethyl-2-methylpropan-1-ol), diglycerol (=bis(2,3-dihydroxypropyl)ether);
polyols of the kind obtained by reduction of dimerized fatty acids.

More particularly preferred are glycol dimercaptoacetate, trimethylolpropane trimercaptoacetate, and butanediol dimercaptoacetate.

Polymercaptans considered to be the most preferred are dimercaptans of the formula (VI).

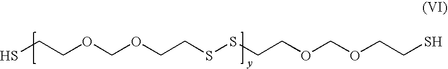

In this formula, y is a value from 1 to 45, more particularly from 5 to 23. The preferred molecular weights are between 800 and 7500 g/mol, more particularly between 1000 and 4000 g/mol.

Polymercaptans of this kind are available commercially among the Thiokol LP series from Toray Fine Chemicals Co.

Preferred hydroxyphenyl-functional carboxylic esters are methyl ortho-, meta- or para-hydroxybenzoate, ethyl ortho-, meta- or para-hydroxybenzoate, isopropyl ortho-, meta- or para-hydroxybenzoate, benzoxazolinone, benzofuran-2-one, benzodihydropyrone.

Preferred dicarboxylic anhydrides are phthalic anhydride, maleic anhydride, succinic anhydride, methylsuccinic anhydride, isobutenesuccinic anhydride, phenylsuccinic anhydride, itaconic anhydride, cis-1,2,3,6-tetrahydrophthalic anhydride, hexahydrophthalic anhydride, norbornane-2,3-dicarboxylic anhydride, hexahydro-4-methylphthalate anhydride, glutaric anhydride, 3-methylglutaric anhydride, (±)-1,8,8-trimethyl-3-oxabicyclo[3.2.1]octane-2,4-diones, oxepan-2,7-dione.

This reaction takes place preferably in the presence of a catalyst at elevated temperatures from 50° C. to 150° C., preferably 70° C. to 130° C.

As a catalyst it is preferred to use triphenylphosphine; the reaction may take place optionally under inert gas or reduced pressure. Examples of other catalysts which can be used are tertiary amines, quaternary phosphonium salts or quaternary ammonium salts.

For this reaction, however, it is also possible not to use a catalyst; the reaction in that case, however, takes place at elevated temperatures from 80° C. to 200° C., preferably 90° C. to 180° C.

It is preferred to select a molar excess of the epoxide groups relative to the carboxyl and/or phenol groups in the reaction mixture. In this case the ratio of the number of epoxide groups to the number of carboxyl and/or phenol groups is 1:1 to 50:1, preferably 1:1 to 20:1, more preferably 1:1 to 10:1.

Use is made as polyisocyanate (B), in one preferred embodiment, of a diisocyanate or a triisocyanate.

Polyisocyanates which can be used include aliphatic, cycloaliphatic or aromatic polyisocyanates, more particularly diisocyanates.

More particularly suitable are the following:
1,6-hexamethylene diisocyanate (HDI), 2-methylpentamethylene 1,5-diiso-cyanate, 2,2,4- and 2,4,4-trimethyl-1,6-hexamethylene diisocyanate (TMDI), 1,10-decamethylene diisocyanate, 1,12-dodecamethylene diisocyanate, lysine diisocyanate and lysine ester diisocyanate, cyclohexane 1,3- and 1,4-diisocyanate and any desired mixtures of these isomers, 1-methyl-2,4- and -2,6-diisocyanatocyclohexane and any desired mixtures of these isomers (HTD₁ or H₆TDI), 1-isocyanato-3,3,5-trimethyl-5-isocyanatomethylcyclo-hexane (=isophorone diisocyanate or IPDI), perhydro-2,4′- and -4,4′-diphenylmethane diisocyanate (HMDI or H₁₂MDI), 1,4-diisocyanato-2,2,6-trimethylcyclohexane (TMCDI), 1,3- and 1,4-bis(isocyanatomethyl)-cyclohexane, m- and p-xylylene diisocyanate (m- and p-XDI), m- and p-tetramethyl-1,3- and -1,4-xylylene diisocyanate (m- and p-TMXDI), bis(1-isocyanato-1-methylethyl)naphthalene.
2,4- and 2,6-tolylene diisocyanate and any desired mixtures of these isomers (TDI), 2,4′-, and 2,2′-diphenylmethane diisocyanate and any desired mixtures of these isomers (MDI), 1,3- and 1,4-phenylene diisocyanate, 2,3,5,6-tetramethyl-1,4-diisocyanatobenzene, naphthalene 1,5-diisocyanate (NDI), 3,3′-dimethyl-4,4′-diisocyanatobiphenyl (TODI), dianisidine diisocyanate (DADI).
Oligomers (e.g., biurets, isocyanurates) and polymers of the aforementioned monomeric diisocyanates.
Any desired mixtures of the aforementioned polyisocyanates.
   Preference is given to monomeric diisocyanates, more particularly MDI, TDI, HDI, and IPDI.

The polyisocyanate (B) is used more particularly in an amount such that the ratio of NCO groups to OH groups of the hydroxyl-containing polymer (A) described is in a proportion >1 to 2, resulting in isocyanate-group-terminal polyaddition products. More particularly suitable are those polyaddition products which arise from an NCO/OH proportion ratio of between 1.5 and 2. To a person skilled in the art it is clear that he or she should increase the amount of polyisocyanate (B) accordingly when there are other NCO-reactive compounds present during this reaction, such as the isocyanate-reactive polymers (C) described below, for example.

In one variant of the production method of the invention there is additionally at least one further isocyanate-reactive polymer (C) present during the reaction of the at least one polymer (A) with at least one polyisocyanate (B). This isocyanate-reactive polymer (C) is preferably selected from the group consisting of poly(oxyalkylene) polyol, polyester polyol, polycarbonate polyol, poly(oxyalkylene) polyamine, polyalkylene polyol, and polymercaptan. For examples of these groups of substances, reference may be made to the above remarks relating to R¹—[XH]ₙ.

Polymer (A) and the further polymer(s) are preferably present in a mixing ratio by weight of 1:100 to 100:1.

According to a second aspect, the present invention provides an isocyanate-group-terminal polyaddition product formed from
i) a polymer (A) as described above; and
ii) a polyisocyanate (B).

The isocyanate-group-terminal polyaddition product of the present invention may be obtained, furthermore, by a method as defined above.

As mentioned at the outset, the isocyanate-group-terminal polyaddition product of the invention can be used particularly in adhesives, and the present invention accordingly provides an adhesive composition comprising said product.

In contrast to butadiene/acrylonitrile copolymer-based addition products, the polymers (A) described herein that contain at least two hydroxyl groups, and also the isocyanate-group-terminal polyaddition product described, have a significantly lower viscosity, which brings significant advantages with it in respect of their use and processing. Moreover, access to the starting materials for their production is significantly easier, which both entails financial advantages and increases the possibility of being able to provide products tailored to specific requirements.

On the basis of its special properties, the present invention embraces the use of the polymer (A) in polyurethane chemistry, preferably as curing component or as part of a curing component in two-pack adhesives. Besides this there are diverse other applications conceivable, as for example in PU for seals, hoses, flooring, coatings, sealants, skis, textile fibers, running tracks in stadiums, encapsulating compositions, and many others.

### EXAMPLES

The examples which follow serve merely to illustrate the invention described in detail above, and in no way whatsoever limit the invention.

### Preparation of Polymers Having at Least Two Hydroxyl Groups

### A-1

300 g of Dynacoll® 7250 (polyester polyol, OH number about 22.5 mg KOH/g, Evonik) and 18.55 g of hexahydrophthalic anhydride were combined. They were stirred under a nitrogen atmosphere at 150° C. for 2 hours and under reduced pressure for 30 minutes. This gave a polymer having an acid number of 21.6 mg KOH/g (theoretically 21.2 mg KOHIg). 130 g of this carboxylic acid-terminated polymer (50 mmol of COON groups) were combined with 13.1 g of Polypox® R⁷ (p-t-butylphenyl glycidyl ether; epoxide content about 4.20 eq/kg: 55 mmol of epoxide groups, UPPC) and 0.29 g of triphenylphosphine. The mixture was stirred under a nitrogen atmosphere at 120° C. for 5 hours until a constant epoxide concentration was reached (final epoxide content: 0.14 eq/kg, theoretical: 0.04 eq/kg). This gave a viscous polymer having an OH number of about 19.6 mg KOH/g.

### A-2

600 g of Poly-THF® 2000 (polyether polyol, OH number about 57.0 mg KOH/g, BASF) and 90.3 g of phthalic anhydride were combined. They were stirred under a nitrogen atmosphere at 150° C. for 2 hours and under reduced pressure for 30 minutes. This gave a polymer having an acid number of 49.3 mg KOH/g (theoretically 49.5 mg KOHIg). 200 g of this carboxylic acid-terminated polymer (176 mmol of COOH groups) were combined with 300 g of Epilox® A 17-01 (distilled bisphenol A diglycidyl ether; epoxide content about 5.75 eq/kg: 1725 mmol of epoxide groups, Leuna-Harze GmbH) and 1.0 g of triphenylphosphine. The mixture was stirred under reduced pressure at 120° C. for 5 hours until a constant epoxide concentration was reached (final epoxide content: 3.12 eq/kg, theoretical: 3.10 eq/kg). This gave a viscous polymer having an OH number of about 19.7 mg KOH/g.

### A-3

200 g of Jeffamine® D2000 (amine content about 1 eq/kg, 200 mmol of amine, Huntsman), 42.0 g (276 mmol) of methyl 4-hydroxybenzoate, and 0.3 g of dibutyltin dilaurate were weighed out into a 500 ml three-neck flask and homogenized using a magnetic stirrer rod under a nitrogen atmosphere. The mixture was refluxed at 220° C. for 30 hours, in the course of which there was a significant decrease in the ester band at about 1723 cm⁻¹ in the IR, while at the same time the amide band at about 1659 cm⁻¹ increased until it reached a constant intensity. The excess methyl 4-hydroxybenzoate was distilled off under a high vacuum at about 0.2 mbar and 160° C. This gave a light brown liquid of low viscosity which according to IR analysis no longer contained any ester groups, and had a calculated phenol content of about 48.7 mg/g KOH. 38.0 g of this polymer (about 33 mmol of aromatic OH groups) were combined with 70.6 g of Epilox® A 17-01 (distilled bisphenol A diglycidyl ether; epoxide content about 5.75 eq/kg: 406 mmol of epoxide groups, Leuna-Harze GmbH), 0.1 g of butylated hydroxytoluene (BHT) (free-radical scavenger), and 0.21 g of triphenylphosphine. The mixture was stirred under a nitrogen atmosphere at 130° C. for 7 hours until a constant epoxide concentration was reached (final epoxide content: 3.49 eq/kg, theoretical: 3.43 eq/kg). This gave a viscous polymer having a calculated OH number of about 17.0 mg KOH/g.

### A-4

200 g of Jeffamine® D2000 (amine content about 1 eq/kg, 200 mmol of amine, Huntsman), 42.0 g (276 mmol) of methyl 4-hydroxybenzoate, and 0.3 g of dibutyltin dilaurate were weighed out into a 500 ml three-neck flask and homogenized using a magnetic stirrer rod under a nitrogen atmosphere. The mixture was refluxed at 220° C. for 30 hours, in the course of which there was a significant decrease in the ester band at about 1723 cm⁻¹ in the IR, while at the same time the amide band at about 1659 cm⁻¹ increased until it reached a constant intensity. The excess methyl 4-hydroxybenzoate was distilled off under a high vacuum at about 0.2 mbar and 160° C. This gave a light brown liquid of low viscosity which according to IR analysis no longer contained any ester groups, and had a calculated phenol content of about 48.7 mg/g KOH.

100.0 g of this polymer (about 86.8 mmol of aromatic OH groups) were combined with 24.3 g of Polypox® R7 (p-t-butylphenyl glycidyl ether; epoxide content about 4.20 eq/kg: 102 mmol of epoxide groups, UPPC), 0.1 g of butylated hydroxytoluene (BHT) (free-radical scavenger), and 0.25 g of triphenylphosphine. The mixture was stirred under a nitrogen atmosphere at 130° C. for 7 hours until a constant epoxide concentration was reached (final epoxide content: 0.21 eq/kg, theoretical: 0.11 eq/kg). This gave a viscous polymer having a calculated OH number of about 39.2 mg KOH/g.

### Preparation of Polymers of Polyurethane Prepolymers Containing Isocyanate Groups

### NCO-1

120 g of the hydroxy-functional polymer A-1 (OH number about 19.6 mg KOH/g), 10.3 g of isophorone diisocyanate, 0.12 g of butylated hydroxytoluene (BHT) (free-radical scavenger), and 0.03 g of dibutyltin dilaurate were combined. The mixture was stirred under reduced pressure at 90° C. for 2 hours, giving a viscous, NCO-terminated polymer (final NCO content: 1.63%, theoretical 1.53%).

### NCO-2

150 g of the hydroxy-functional polymer A-2 (OH number about 19.7 mg KOH/g), 13.0 g of isophorone diisocyanate, 0.08 g of butylated hydroxytoluene (BHT) (free-radical scavenger), and 0.04 g of dibutyltin dilaurate were combined. The mixture was stirred under reduced pressure at 100° C. for 2 hours, giving a viscous, NCO-terminated polymer (final NCO content: 1.22%, theoretical 1.56%).

### NCO-3

106 g of the hydroxy-functional polymer A-3 (OH number about 17.0 mg KOH/g) and 9.1 g of isophorone diisocyanate were combined. The mixture was stirred under reduced pressure at 90° C. for 3 hours, giving a viscous, NCO-terminated polymer (final NCO content: about 1.5%).

### NCO-4

108 g of the hydroxy-functional polymer A-4 (OH number about 39.2 mg KOH/g) and 20.4 g of isophorone diisocyanate were combined. The mixture was stirred under reduced pressure at 90° C. for 3 hours, giving a viscous, NCO-terminated polymer (final NCO content: about 3.3%).

### Production of Compositions

Compositions were produced by mixing the constituents according to table 1 in parts by weight.

The isocyanate-terminated polymers P1 and P2 required for this purpose were prepared as follows:

### P1:

590 g of polyoxypropylene diol (Acclaim® 4200 N, Bayer MaterialScience AG; OH number 28.5 mg KOH/g), 1180 g of polyoxypropylene-polyoxyethylene triol (Caradol® MD34-02, Shell Chemicals Ltd., UK; OH number 35.0 mg KOH/g) and 230 g of isophorone diisocyanate (IPDI; Vestanat® IPDI, Evonik Degussa AG) were reacted by a known method at 80° C. to give an NCO-terminated polyurethane polymer having a free isocyanate group content of 2.1% by weight.

### P2:

1300 g of polyoxypropylene diol (Acclaim® 4200 N, Bayer MaterialScience AG; OH number 28.5 mg KOH/g), 2600 g of polyoxypropylene-polyoxyethylene triol (Caradol® MD34-02, Shell Chemicals Ltd., UK; OH number 35.0 mg KOH/g), 600 g of 4,4′-methylenediphenyl diisocyanate (4,4′-MDI; Desmodur® 44 MC L, Bayer MaterialScience AG), and 500 g of diisodecyl phthalate (DIDP; Palatinol® Z, BASF SE, Germany) were reacted by a known method at 80° C. to give an NCO-terminated polyurethane polymer having a free isocyanate group content of 2.05% by weight.

### Measurement Methods

20 g of each composition were pressed between two moisture-permeable sheets to form plaques 2 mm thick. Dumbbells were punched from the 2 mm thick films, cured at 23° C. and 50% relative atmospheric humidity for 1 week, and the dumbbells were pulled with a tensioning speed of 200 mm/min. From this test, determinations were made of the tensile strength (“TS”), elongation at break (“EB”), and modulus of elasticity. The modulus of elasticity in the range between 0.5% and 5% elongation (“E_{0.5-5}%”) was reported in table 1.

TABLE 1
Compositions and results.

| | Ref. | 1 | 2 | 3 | 4 |
|---|---|---|---|---|---|
| P1 | 62.5 | 25 | 37.5 | 37.5 | 25 |
| P2 | 62.5 | 62.5 | 62.5 | 62.5 | 62.5 |
| Diisodecyl | 25 | 25 | 0 | 0 | 25 |
| phthalate (DIDP) | | | | | |
| p-Toluenesulfonyl | 0.125 | 0.125 | 0.125 | 0.125 | 0.125 |
| isocyanate | | | | | |
| Kaolin | 75 | 75 | 75 | 75 | 75 |
| Dibutyltin dilaurate | 5 | 5 | 5 | 5 | 5 |
| (3% in DIDP) | | | | | |
| NCO-1 | | 37.5 | | | |
| NCO-2 | | | 50 | | |
| NCO3 | | | | 50 | |
| NCO4 | | | | | 37.5 |
| TS [MPa] | 3.2 | 2.7 | 3.7 | 2.5 | 2.5 |
| EB [%] | 420 | 745 | 385 | 310 | 520 |
| E_{0.5-5%}[MPa] | 2.3 | 1.2 | 1.6 | 2.8 | 1.7 |

It was also found that all of the compositions could be used to bond a variety of substrates (glass, glass ceramic, steel, aluminum, painted metal sheets) adhesively, with good adhesion being obtained in each case.

1. A method for producing polyurethanes, comprising the steps of:
a) providing at least one polymer (A) which has at least two hydroxyl groups and which is obtained by the reaction of a polymer having at least two carboxyl groups and/or phenol groups of the formula (I) or (II) with at least one compound having at least one glycidyl group; 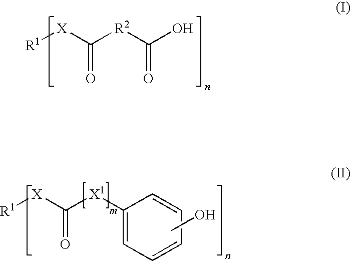
where
X is O, NR⁴ or S, with R⁴ in turn being H or an alkyl group having 1 to 10 carbon atoms;
X¹ is NR⁴, CH₂ or C₂H₄;
R¹ is an n-valent radical of a polymer R¹—[XH]ₙ following removal of n groups XH;
R² is a radical of a dicarboxylic acid following removal of the two carboxyl groups optionally substituted alkylene group having 1 to 6 carbon atoms, or an optionally substituted phenylene group;
and n is a value from 1.7 to 4;
and m is 0 or 1;
b) reacting the at least one polymer (A) with at least one polyisocyanate (B).

2. The method of claim 1, wherein the compound having at least one glycidyl group is a glycidyl ether, a glycidyl ester, a glycidylamine, a glycidylamide or a glycidylimide.

3. The method of claim 1, wherein the polymer (A) is obtained by reacting carboxyl-terminated polymers having a functionality of at least 2 with aromatic glycidyl ethers.

4. The method of claim 1, wherein the compound having at least one glycidyl group is selected from mono- or polyfunctional glycidyl ethers or glycidyl esters.

5. (canceled)

6. The method of claim 1, wherein the polymer (A) is prepared by reacting at least one glycidyl ether or glycidyl ester with at least one phenol-group-terminated or carboxyl-terminated polymer obtained by reacting at least one hydroxyl-, amine- or thiol-functional polymer with at least one hydroxyphenyl-functional carboxylic acid or ester thereof and at least one dicarboxylic acid or dicarboxylic anhydride.

7. The method of claim 6, wherein the reaction takes place in the presence of a catalyst at elevated temperatures from 50° C.

8. The method of claim 7, wherein the catalyst is triphenylphosphine.

9. The method of claim 6, wherein the reaction takes place in the absence of a catalyst at elevated temperatures from 80° C. to 200° C.

10. The method of claim 1, in which a molar excess of the epoxide groups over the carboxyl and/or phenol groups in the reaction mixture is selected.

11. The method as claimed in claim 10, wherein the ratio of the number of epoxide groups to the number of carboxyl and/or phenol groups is 1:1 to 50:1.

12. The method of claim 1, wherein a diisocyanate or a triisocyanate is used as polyisocyanate (B).

13. The method of claim 1, wherein additionally there is also at least one further isocyanate-reactive polymer (C) present for the reaction of the at least one polymer (A) with at least one polyisocyanate (B).

14. The method of claim 13, wherein the isocyanate-reactive polymer (C) is selected from the group consisting of poly(oxyalkylene) polyol, polyester polyol, polycarbonate polyol, poly(oxyalkylene) polyamine, polyalkylene polyol and polymercaptan.

15. The method of claim 13, wherein polymer (A) and the further polymer or polymers (C) are present in a mixing ratio by weight of 1:100 to 100:1.

16. An isocyanate-group-terminal polyaddition product formed from
i) a polymer (A) as defined in a method of claim 1; and
ii) a polyisocyanate (B).

17. An isocyanate-group-terminal polyaddition product obtainable by a method of claim 1.

18. An adhesive comprising an isocyanate-group-terminal polyaddition product of claim 16.

19. A method comprising:
providing a polymer (A) of claim 1 in polyurethane chemistry.

20. A method comprising:
providing a polymer (A) of claim 19 as a curing component or part of a curing component in two-pack adhesives.

21. A method for producing polyurethanes, comprising providing the polymer (A) as defined in claim 1.

22. The method of claim 4, in which the glycidyl ether or glycidyl ester is a glycidyl ether which is selected from the group consisting of glycidyl neodecanoate, glycidyl benzoate, diglycidyl phthalate, octyl glycidyl ether, decyl glycidyl ether, butanediol diglycidyl ether, hexanediol diglycidyl ether, cyclohexanedimethanol diglycidyl ether, trimethylolpropane triglycidyl ether, tert-butylphenol glycidyl ether, cresyl glycidyl ether, Cardanol glycidyl ether (Cardanol=3-pentadecenylphenol), diglycidyl ethers of bisphenols, liquid epoxy resins, bisphenol F diglycidyl ether (distilled and undistilled) and bisphenol A diglycidyl ether (distilled and undistilled).

23. The method of claim 1, wherein R¹ is a poly(oxyalkylene) polyol, polyester polyol, poly(oxyalkylene)polyamine, polyalkylene polyol, polycarbonate polyol, polymercaptan or polyhydroxypolyurethane following removal of the hydroxyl, amine or mercaptan groups.
